(19) United States
(12) Patent Application Publication
(10) Pub. No.: US 2026/0360604 A1
(43) Pub. Date: Nov. 12, 2026

(54) REACTOR, CONVERTER, AND POWER CONVERSION APPARATUS

(71) Applicants: AutoNetworks Technologies, Ltd., Yokkaichi-shi, Mie (JP); Sumitomo Wiring Systems, Ltd., Yokkaichi-shi, Mie (JP); Sumitomo Electric Industries, Ltd., Osaka-shi, Osaka (JP); Denso Corporation, Kariya-shi, Aichi (JP)

(72) Inventors: Yoshinori TAKAI, Yokkaichi-shi, Mie (JP); Masato NADA, Yokkaichi-shi, Mie (JP); Takahiro OTA, Kariya-shi, Aichi (JP)

(73) Assignees: AutoNetworks Technologies, Ltd., Yokkaichi-shi, Mie (JP); Sumitomo Wiring Systems, Ltd., Yokkaichi-shi, Mie (JP); Sumitomo Electric Industries, Ltd., Osaka-shi, Osaka (JP); Denso Corporation, Kariya-shi, Aichi (JP)

(21) Appl. No.: 19/488,224

(22) PCT Filed: May 10, 2024
(86) PCT No.: PCT/JP2024/017515

§ 371 Date: Nov. 26, 2025

(30) Foreign Application Priority Data
May 30, 2023 (JP) 2023-088801

(51) Int. Cl. H01F 27/24; B60L 15/00; H01F 27/28; H01F 27/32; H01F 37/00

(52) U.S. Cl. CPC H01F 27/24; H01F 27/2828; H01F 27/325; H01F 37/00; B60L 15/007; B60L 2210/42

(57) ABSTRACT

A reactor including: a coil constituted by a winding wire; and a magnetic core having: an inner core portion disposed inside the coil; and an outer core portion disposed outside the coil, wherein the outer core portion has a cutout, and an end of the winding wire is led out through the cutout.

### CROSS-REFERENCE TO RELATED APPLICATIONS

This application is the U.S. national stage of PCT/JP2024/017515 filed on Oct. 5, 2024, which claims priority of Japanese Patent Application No. 2023-088801 filed May 30, 2023, the contents of which are incorporated herein.

### TECHNICAL FIELD

The present disclosure relates to a reactor, a converter, and a power conversion apparatus.

### BACKGROUND

A reactor described in JP 2006-351722A includes a coil and a magnetic core. The coil has a first winding portion and a second winding portion, each constituted by a winding wire wound in a helical shape. The magnetic core includes a first middle core, a second middle core, a first end core, and a second end core. The first middle core is disposed inside the first winding portion. The second middle core is disposed inside the second winding portion. The first end core connects a first end of the first middle core and a first end of the second middle core. The second end core connects a second end of the first middle core and a second end of the second middle core. Ends of the winding wires constituting the first winding portion and the second winding portion are led out through an upper portion of either the first end core or the second end core, for example.

There is demand for a thin reactor. If the reactor can be configured to be thin, it is expected that its size and weight will decrease, and its flexibility in arrangement and heat dissipation structure will increase.

An object of the present disclosure is to provide a thin reactor. Another object of the present disclosure is to provide a converter including the above reactor. Yet another object of the present disclosure is to provide a power conversion apparatus including the above converter.

### SUMMARY

A reactor according to the present disclosure includes: a coil constituted by a winding wire; and a magnetic core having: an inner core portion disposed inside the coil; and an outer core portion disposed outside the coil, and the outer core portion has a cutout, and an end of the winding wire is led out through the cutout.

### EFFECTS OF THE PRESENT DISCLOSURE

The above reactor can form a thin reactor.

### BRIEF DESCRIPTION OF DRAWINGS

FIG. 1 is a perspective view of a reactor according to Embodiment 1.

FIG. 2 is a perspective view of a coil constituting the reactor in FIG. 1.

FIG. 3 is a perspective view of a magnetic core constituting the reactor in FIG. 1.

FIG. 4 is a perspective view of a spacer constituting the reactor shown in FIG. 1.

FIG. 5 is a perspective view of a reactor according to Embodiment 2.

FIG. 6 is a perspective view of a reactor according to Embodiment 3.

FIG. 7 is a perspective view of a coil constituting the reactor in FIG. 6.

FIG. 8 is a perspective view of a magnetic core constituting the reactor in FIG. 6.

FIG. 9 is a perspective view of a spacer constituting the reactor in FIG. 6.

FIG. 10 is a perspective view of a reactor according to Embodiment 4.

FIG. 11 is a configuration diagram schematically showing a power system of a hybrid vehicle.

FIG. 12 is a circuit diagram showing an example of a power conversion apparatus including a converter.

### DETAILED DESCRIPTION OF PREFERRED EMBODIMENTS

First, aspects of the present disclosure will be listed and described.

In a first aspect, a reactor according to an aspect of the present disclosure includes: a coil constituted by a winding wire; and a magnetic core having: an inner core portion disposed inside the coil; and an outer core portion disposed outside the coil. The outer core portion has a cutout, and an end of the winding wire is led out through the cutout.

In this reactor, the outer core portion has a cutout into which a winding end is fitted. This can reduce the likelihood of the winding end projecting from the surface of the outer core portion. Therefore, the thickness of the outer core can be reduced compared to a reactor in a comparative structure with no cutout, in which an end of a winding wire is placed on a surface of an outer core portion.

In a second aspect, the reactor according to the first aspect may further include a spacer disposed between an end face of the coil and the outer core portion, and the spacer may have a cutout through which the end of the winding wire is led out.

In this reactor, the spacer has a cutout into which a winding end is fitted. This can reduce the likelihood of the winding end projecting from the surface of the spacer. Therefore, the outer core can be made thinner compared to a reactor in a comparative structure with no cutout, in which an end of a winding wire is placed on a surface of a spacer.

In a third aspect, the reactor according to the first or the second aspect may also be configured as follows. The coil has: a first winding portion and a second winding portion that are independent members arranged in parallel; a first winding end and a second winding end that are led out from the first winding portion; and a third winding end and a fourth winding end that are led out from the second winding portion. The outer core portion includes: a first outer core portion facing a first end face of the coil; and a second outer core portion facing a second end face of the coil. The cutout includes: a first cutout provided at one of a first end and a second end of the first outer core portion; a second cutout provided between the first end and the second end of the first outer core portion; a third cutout provided at one of a first end and a second end of the second outer core portion; and a fourth cutout provided between the first end and the second end of the second outer core portion. The first winding end is led out through the first cutout, the second winding end is led out through the fourth cutout, the third winding end is led out through the second cutout, and the fourth winding end is led out through the third cutout.

This reactor includes a coil having two independent winding portions, and each winding portion has two winding ends. Of these four winding ends, the first winding end of the first winding portion is led out from the first cutout provided at one end of the first outer core portion, and the second winding end of the first winding portion is led out from the fourth cutout provided at an intermediate portion of the second outer core portion. The third winding end of the second winding portion is led out from the second cutout provided at an intermediate portion of the first outer core portion, and the fourth winding end of the second winding portion is led out from the third cutout provided at one end of the second outer core portion. That is, two winding ends are led out from each of the first outer core portion and the second outer core portion. Since the winding ends of each independent winding portion can be led out from the first outer core portion and the second outer core portion that are separate from each other, the winding ends can be disposed at separate positions. This arrangement of the winding ends facilitates connection to terminals to which the winding ends are connected.

In a fourth aspect, the reactor according to the first or the second aspect may also be configured as follows. The coil has: a first winding portion and a second winding portion that are independent members arranged in parallel; a first winding end and a second winding end that are led out from the first winding portion; and a third winding end and a fourth winding end that are led out from the second winding portion. The outer core portion includes: a first outer core portion facing a first end face of the coil; and a second outer core portion facing a second end face of the coil. The cutout includes: a first cutout provided at a first end of the first outer core portion; a second cutout provided at a second end of the first outer core portion; a third cutout provided at a first end of the second outer core portion; and a fourth cutout provided at a second end of the second outer core portion. The first winding end is led out through the first cutout, the second winding end is led out through the fourth cutout, the third winding end is led out through the second cutout, and the fourth winding end is led out through the third cutout.

This reactor includes a coil having two independent winding portions, each of which has two winding ends. Of these four winding ends, the first winding end of the first winding portion is led out through the first cutout provided at one end of the first outer core portion, and the second winding end of the first winding portion is led out through the fourth cutout provided at one end of the second outer core portion. The third winding end of the second winding portion is led out through the second cutout provided at the other end of the first outer core portion, and the fourth winding end of the second winding portion is led out through the third cutout provided at the other end of the second outer core portion. That is, two winding ends are led out from the ends of each of the first outer core portion and the second outer core portion. Since the winding ends of each independent winding portion can be led out from the first outer core portion and the second outer core portion that are separate from each other, the winding ends can be disposed at separate positions. This arrangement of the winding ends facilitates connection to terminals to which the winding ends are connected. With this reactor, the winding ends can be led out from positions further separate than in the reactor according to (3) above.

In a fifth aspect, the reactor according to the first or the second aspect may also be configured as follows. The coil has: a first winding portion and a second winding portion arranged in parallel; a coupling portion connecting the first winding portion and the second winding portion; a first winding end led out from the first winding portion; and a second winding end led out from the second winding portion. The coupling portion is constituted by a portion of the winding wire. The cutout includes: a first cutout provided at one of a first end and a second end of the outer core portion; and a second cutout provided between the first end and the second end of the outer core portion. The first winding end is led out through the first cutout, and the second winding end is led out through the second cutout.

This reactor includes a coil having two connected winding portions, and each winding portion has one winding end. Of these two winding ends, the first winding end of the first winding portion is led out through the first cutout provided at one end of the outer core portion, and the second winding end of the second winding portion is led out through the second cutout provided at an intermediate portion of the outer core portion. That is, two winding ends are led out from the outer core portion. The winding ends of the connected winding portions can be led out through the first and second cutouts provided at separate positions in the outer core portion. This enables the winding ends to be disposed at separate positions. This arrangement of the winding ends facilitates connection to terminals to which the winding ends are connected.

In a sixth aspect, the reactor according to the first or the second aspect may also be configured as follows. The coil has: a first winding portion and a second winding portion arranged in parallel; a coupling portion connecting the first winding portion and the second winding portion; a first winding end led out from the first winding portion; and a second winding end led out from the second winding portion. The coupling portion is constituted by a portion of the winding wire. The cutout includes: a first cutout provided at a first end of the outer core portion; and a second cutout provided at a second end of the outer core portion. The first winding end is led out through the first cutout, and the second winding end is led out through the second cutout.

This reactor includes a coil having two connected winding portions, and each winding portion has one winding end. Of these two winding ends, the first winding end of the first winding portion is led out through the first cutout provided at one end of the outer core portion, and the second winding end of the second winding portion is led out through the second cutout provided at the other end of the outer core portion. That is to say, two winding ends are led out from the outer core portion. The winding ends of the connected winding portions can be led out through the first and second cutouts provided at separate positions in the outer core portion. This enables the winding ends to be disposed at separate positions. This arrangement of the winding ends facilitates connection to terminals to which the winding ends are connected. With this reactor, the winding ends can be led out from positions further separate than in the reactor according to (5) above.

In a seventh aspect, in the reactor according to any of the first to the sixth aspects, the outer core portion may have a rectangular envelope shape having a long side and a short side as viewed from a direction along an axis of the coil, and a ratio of the long side to the short side may be 5.0 or more.

In this reactor, the ratio of the long side to the short side constituting the outer core portion is 5.0 or more, thereby making it possible to form a flat and thin reactor.

In an eighth aspect, in the reactor according to any of the first to the seventh aspects, the coil may have a rectangular envelope shape having a long side and a short side as viewed from a direction along an axis of the coil, and a ratio of the long side to the short side may be 2.5 or more.

In this reactor, the ratio of the long side to the short side constituting the coil is 2.5 or more, thereby making it possible to form a flat and thin reactor.

In a ninth aspect, in the reactor according to any of the second to the eighth aspects, the spacer may have a rectangular envelope shape having a long side and a short side as viewed from a direction along an axis of the coil, and a ratio of the long side to the short side may be 5.0 or more.

In this reactor, the ratio of the long side to the short side constituting the spacer is 5.0 or more, thereby making it possible to form a flat and thin reactor.

In a tenth aspect, the reactor according to any of the second to the ninth aspects may also be configured as follows. The coil has a first coil face and a second coil face opposing each other. The outer core portion has a first outer core face and a second outer core face opposing each other. The spacer has a first main face and a second main face opposing each other. The first coil face, the first outer core face, and the first main face are flush with each other. The second coil face, the second outer core face, and the second main face are flush with each other.

In this reactor, the front faces of the coil, the outer core portion, and the spacer are flush with each other, and the rear faces thereof are also flush with each other. This makes it possible to form a thin reactor having front and rear faces that have substantially no projections or depressions.

In an eleventh aspect, a converter according to an aspect of the present disclosure includes the reactor according to any of the first to the tenth aspects.

This converter including the above reactor can be configured to be thin.

In a twelfth aspect, a power conversion apparatus according to an aspect of the present disclosure includes the converter according to the eleventh aspect.

The power conversion apparatus including the above converter can be configured to be thin.

The details of a reactor according to the present disclosure will be described below with reference to the drawings. In the drawings, the same reference numerals denote the same components. The sizes and the like of the members shown in the drawings are expressed for the purpose of clarifying the description and do not necessarily represent actual dimensional relationships.

### Embodiment 1

### Overview

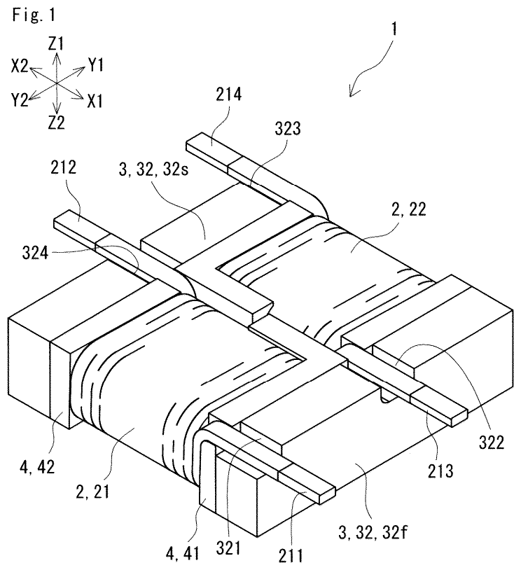

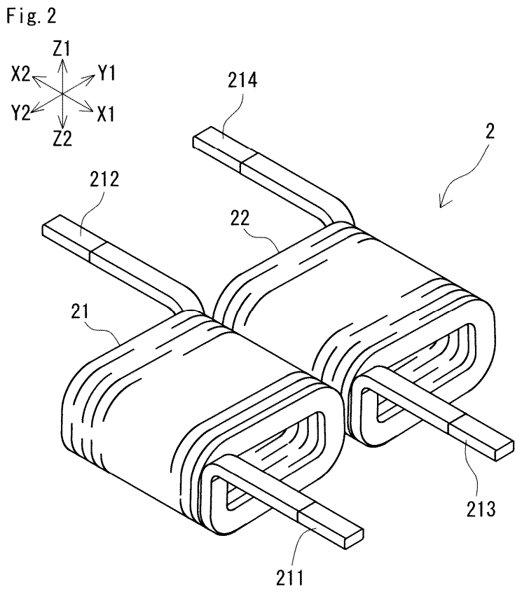

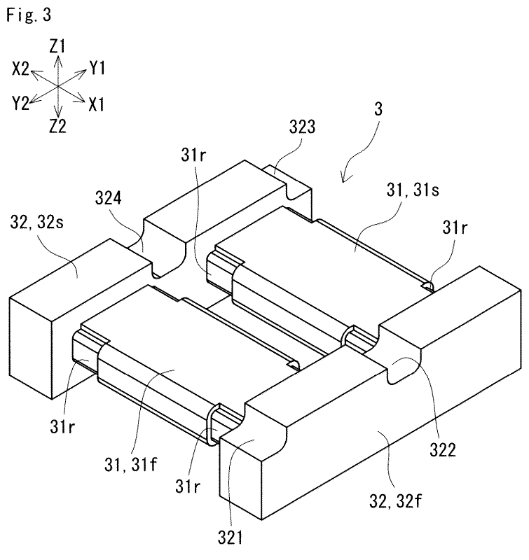

A reactor 1 according to Embodiment 1 will be described with reference to FIGS. 1 to 4. As shown in FIG. 1, a reactor 1 includes a coil 2 and a magnetic core 3. As shown in FIG. 2, the coil 2 includes a first winding portion 21 and a second winding portion 22, a first winding end 211 and a second winding end 212 that are led out from the first winding portion 21, and a third winding end 213 and a fourth winding end 214 that are led out from the second winding portion 22. As shown in FIG. 3, the magnetic core 3 has inner core portions 31 disposed inside the coil 2, and outer core portions 32 disposed outside the coil 2. One feature of the reactor 1 according to Embodiment 1 is that the outer core portions 32 have first to fourth cutouts 321 to 324 through which the first to fourth winding ends 211 to 214 are led out. In the following, the directions and dimensions of the reactor 1 are defined as follows, and the details of each part will be described.

The X1 direction is the direction from second end faces of the first winding portion 21 and the second winding portion 22 toward first end faces of the first winding portion 21 and the second winding portion 22. The second end faces are the end faces of the winding portions 21 and 22 that face the second outer core portion 32s. The first end faces are the end faces of the winding portions 21 and 22 that face the first outer core portion 32f. The Y1 direction is the direction from a first side face of the first winding portion 21 toward a second side face of the second winding portion 22. The first side face of the first winding portion 21 and the second side face of the second winding portion 22 are two side faces that are farthest from each other among the side faces of the winding portions 21 and 22. The Z1 direction is the direction from a bottom face of each of the winding portions 21 and 22 toward an upper face. The bottom face is one of the two faces that connect the side faces of each of the winding portions 21 and 22. The upper face is the remaining face of the two faces that connect the side faces of each of the winding portions 21 and 22. The X1, Y1, and Z1 directions are orthogonal to each other. The X2, Y2, and Z2 directions are directions opposite to the X1, Y1, and Z1 directions, respectively. The dimensions of the reactor 1 and its components along the X1 and X2 directions may be referred to as length, the dimensions along the Y1 and Y2 directions as width, and the dimensions along the Z1 and Z2 directions as height.

### Coil

The coil 2 is constituted by winding wires, as shown in FIG. 2. The coil 2 includes the first winding portion 21 and the second winding portion 22 that are helically wound winding wires. The first winding portion 21 and the second winding portion 22 are arranged in parallel in a direction orthogonal to their axes. That is, the second winding portion 22 is parallel to the first winding portion 21 in the Y1 direction. A slight gap is provided between the first winding portion 21 and the second winding portion 22. The first winding portion 21 and the second winding portion 22 in this example are independent members, and have the same shape, dimensions, and constituent material. Accordingly, the bottom face of the first winding portion 21 and the bottom face of the second winding portion 22 are flush with each other, and the upper face of the first winding portion 21 and the upper face of the second winding portion 22 are flush with each other. The bottom face of the first winding portion 21 and the bottom face of the second winding portion 22 each correspond to a first coil face, and the upper face of the first winding portion 21 and the upper face of the second winding portion 22 each correspond to a second coil face. The following description focuses on the first winding portion 21, and the description of the second winding portion 22 is omitted.

The first winding portion 21 has a flat, rectangular-tube shape. The rectangular tube shape includes a rectangular tube with rounded corners. The first winding portion 21 has a rectangle envelope shape having long sides and short sides. The “envelope shape” refers to the minimum quadrangular shape surrounding the first winding portion 21 when viewed from a direction along the axis thereof. The bottom face and the upper face constituting the first winding portion 21 are faces corresponding to the long sides, and the two side faces constituting the first winding portion 21 are faces corresponding to the short sides. All of the bottom face, upper face, and two side faces include flat surfaces. By using at least one of the bottom face and the upper face as an installation surface with respect to an installation object, the contact area between the coil 2 and the installation object can easily be increased. The installation object is, for example, a case in which a coolant is circulated. The larger the contact area between the coil 2 and the installation object, the more efficiently the reactor 1 can dissipate heat.

A ratio A of the long side to the short side is, for example, 1.7 or more. This ratio A is a ratio with the dimension of the short side as a denominator and the dimension of the long side as a numerator. The larger the value of the ratio A, it can be said that the reactor 1 is flatter and thinner. The ratio A may also be 2.5 or more, 3.0 or more, or 4.0 or more. The upper limit of the ratio A may be set as appropriate in accordance with the required upper limit width of the reactor 1. An example of the upper limit of the ratio A is 6.0. The ratio A in this example is about 1.9.

The first winding portion 21 can be constituted by a known winding wire. The winding wire in this example is a coated flat wire. The coated flat wire includes a conductor wire constituted by a flat copper wire, for example. The coated flat wire includes an insulating coating formed of enamel, for example. The first winding portion 21 in this example is formed by edgewise winding a coated flat wire. Unlike this embodiment, the coil 2 may be formed by flatwise winding a coated flat wire.

The first winding end 211 and the second winding end 212 are led out from the first winding portion 21. The first winding end 211 and the second winding end 212 have their insulating coating removed, exposing the conductor wires. A terminal (not shown) is connected to the exposed conducting wire. An external device (not shown) is connected to the terminal. The external device is, for example, a power supply that feeds electric power to the coil 2.

In this example, when the first winding portion 21 is viewed in the Z2 direction, the first winding end 211 and the second winding end 212 are led out from two diagonally opposite corners of the first winding portion 21. The first winding end 211 and the second winding end 212 extend in directions along the axis of the winding portion 21. More specifically, the first winding end 211 and the second winding end 212 are led out by bending the winding wire flatwise at turns forming the end faces of the first winding portion 21. Further, when the first winding portion 21 is viewed in the X2 direction, the first winding end 211 is located at an upper left corner of the envelope shape. That is, the first winding end 211 is located at an end in the Y2 direction of the envelope shape and an end in the Z1 direction thereof. When the first winding portion 21 is viewed in the X1 direction, the second winding end 212 is located at an upper left corner of the envelope shape. That is, the second winding end 212 is located at an end in the Y1 direction of the envelope shape and an end in the Z1 direction thereof.

### Magnetic Core

The magnetic core 3 is a magnetic member for forming an annular magnetic path by exciting the coil 2. As shown in FIG. 3, the magnetic core 3 in this example is an O-shaped core. The magnetic core 3 is a single piece including the inner core portions 31 and the outer core portions 32. The inner core portions 31 include a first inner core portion 31f disposed inside the first winding portion 21, and a second inner core portion 31s disposed inside the second winding portion 22. The outer core portions 32 include a first outer core portion 32f disposed on the side in the X1 direction of the first inner core portion 31f and the second inner core portion 31s, and a second outer core portion 32s disposed on the side in the X2 direction of the first inner core portion 31f and the second inner core portion 31s. The first inner core portion 31f and the second inner core portion 31s have the same shape, dimensions, and constituent material. Thus, the bottom face of the first inner core portion 31f is flush with the bottom face of the second inner core portion 31s, and the upper face of the first inner core portion 31f is flush with the upper face of the second inner core portion 31s. The first inner core portion 31f and the second inner core portion 31s are arranged in parallel, with a gap therebetween according to the size of the winding portions 21 and 22. The first outer core portion 32f and the second outer core portion 32s also have substantially the same shape and dimensions, and the same constituent material. Thus, the bottom face of the first outer core portion 32f is flush with the bottom face of the second outer core portion 32s, and the upper face of the first outer core portion 32f is flush with the upper face of the second outer core portion 32s. The bottom face of the first outer core portion 32f and the bottom face of the second outer core portion 32s each correspond to a first outer core face, and the upper face of the first outer core portion 32f and the upper face of the second outer core portion 32s each correspond to a second outer core face. The first outer core portion 32f and the second outer core portion 32s are separated from each other and disposed respectively in the X1 direction and the X2 direction with respect to each other. The following description focuses on the first inner core portion 31f and the first outer core portion 32f, and the descriptions of the second inner core portion 31s and the second outer core portion 32s are omitted. The effects from the configurations of the second inner core portion 31s and the second outer core portion 32s are the same as those from the configurations of the first inner core portion 31f and the first outer core portion 32f.

### Inner Core Portion

The first inner core portion 31f is a columnar member. The first inner core portion 31f in this example is formed in a flat rectangular bar shape corresponding to the shape of the inner circumferential portion of the first winding portion 21. The rectangular bar shape may include a square bar with rounded corners. The envelope shape of the first inner core portion 31f is a rectangular shape having long sides and short sides. The “envelope shape” refers to a minimum quadrangular shape surrounding the first inner core portion 31f when the first inner core portion 31f is viewed from a direction along the axis of the first inner core portion 31f. The bottom face and the upper face that constitute the first inner core portion 31f are faces corresponding to the long sides, and the two side faces that constitute the first inner core portion 31f are faces corresponding to the short sides. All of the bottom face, upper face, and two side faces include flat surfaces. Among the outer faces of the first inner core portion 31f, the faces opposing the first winding portion 21 are in contact with the inner faces of the first winding portion 21 over the entire circumference. This allows heat from the first winding portion 21 to easily dissipate to the outside of the reactor 1 through the first inner core portion 31f. This also makes it easy to maintain the magnetic path area of the first inner core portion 31f in the inner circumferential portion of the coil 2.

A ratio B of the long side to the short side of the first inner core portion 31f is 2.5 or more, for example. This ratio B is a ratio with the dimension of the short side as a denominator and the dimension of the long side as a numerator. The larger the value of the ratio B, it can be said that the first inner core portion 31f is flatter and thinner. This ratio B may also be 4.0, 4.5 or more, or 5.0 or more. The upper limit of the ratio B may be set as appropriate in accordance with the required upper limit width of the reactor 1. An example of the upper limit of the ratio B is 7.0. The ratio B in this example is about 2.8.

The first inner core portion 31f in this example has a longer length than the first winding portion 21. Spacers 4, which will be described later, are disposed at respective ends of the first inner core portion 31f. The first inner core portion 31f also includes areas covered by the spacers 4. The outer faces of the first inner core portion 31f are in contact with the inner faces of the first winding portion 21 and the inner faces of the spacers 4. This is because, as will be described later, the magnetic core 3 is molded together with the coil 2 and the spacers 4 into a molded body of a composite material.

The first inner core portion 31f has a plurality of recesses 31r. The recesses 31r are recesses formed in correspondence with later-described guide portions 41g and 42g of the spacers 4. With the recesses 31r, the spacers 4 and the first inner core portion 31f can be coupled firmly. Each recess 31r in this example has a C-shape extending from a corresponding side face to the bottom face and the upper face of the first inner core portion 31f. The recesses 31r in this example are located near four respective corners of the first inner core portion 31f when the magnetic core 3 is viewed in the Z2 direction. The number of recesses 31r in this example is four for the first inner core portion 31f. That is, the second inner core portion 31s also has four recesses 31r, and therefore the magnetic core 3 has a total of eight recesses 31r. The shape, arrangement, location, and number of recesses 31r are not limited to those in this example, and can be properly selected. Note that the recesses 31r are not essential components of the magnetic core 3.

### Outer Core Portion

The first outer core portion 32f is a columnar member. The first outer core portion 32f in this example is a prismatic member having a longer width than its length and height. This prismatic shape may also include a prismatic shape with at least one corner of the first outer core portion 32f rounded. The first outer core portion 32f in this example has a rectangular lateral cross-sectional shape taken by a plane including the X1 and Z1 directions.

The envelope shape of the first outer core portion 32f is a rectangle having long sides and short sides. The “envelope shape” refers to a minimum quadrangular shape surrounding the first outer core portion 32f when the first outer core portion 32f is viewed from a direction along the axis of the first winding portion 21. The bottom face and the upper face that constitute the first outer core portion 32f are faces corresponding to the long sides, and the two side faces that constitute the first outer core portion 32f are faces corresponding to the short sides. All of the bottom face, upper face, and two side faces include flat surfaces.

A ratio C of the long side to the short side of the first outer core portion 32f is, for example, 3.5 or more. This ratio C is a ratio with the dimension of the short side as a denominator and the dimension of the long side as a numerator. The larger the value of the ratio C, it can be said that the first outer core portion 32f is flatter and thinner. The ratio C may also be 5.0, 6.0 or more, or 7.0 or more. The upper limit of the ratio C may be set as appropriate in accordance with the required upper limit width of the reactor 1. An example of the upper limit of the ratio C is 10.0. The ratio C in this example is about 3.9.

The width of each outer core portion 32 is smaller than the width of the coil 2, i.e., the total width of the first winding portion 21 and the second winding portion 22 arranged in parallel. The width of each outer core portion 32 may be greater than or equal to the width of the coil 2.

The height of the first outer core portion 32f is greater than that of the first inner core portion 31f. That is, a step is formed between an end of the first inner core portion 31f and the first outer core portion 32f. This step is filled by the spacer 4, which will be described later.

The first outer core portion 32f has a first cutout 321 and a second cutout 322. The first cutout 321 is provided at an end in the Y2 direction of the first outer core portion 32f. Magnetic flux flows while bending toward the first inner core portion 31f or the second inner core portion 31s. Thus, even though the end of the first outer core portion 32f in the Y1 or Y2 direction is partially cut out, the amount of magnetic flux is unlikely to decrease substantially. The second cutout 322 is provided between the ends in the Y1 and Y2 directions of the first outer core portion 32f. The second cutout 322 in this example is provided at a center portion of the first outer core portion 32f. The center portion of the first outer core portion 32f also serves as a main magnetic path. From the standpoint of suppressing a decrease in the magnetic path area, the depth of the second cutout 322 may be less than half the height of the first outer core portion 32f, for example. This depth is the length from the upper face of the first outer core portion 32f to the most distal position in the second cutout 322 in the Z2 direction. The positions at which the first cutout 321 and the second cutout 322 are provided may be positions different from those described above as long as the third winding end 213 of the second winding portion 22 and the first winding end 211 can be led out.

The first cutout 321 is provided at a corner constituted by the upper face and a side face of the first outer core portion 32f. The shape of the first cutout 321 when the first outer core portion 32f is viewed in the X2 direction is a fan shape with an internal angle of 90 degrees. Note that the shape of the first cutout 321 is not limited to a fan shape, and may also be a rectangular or triangular shape. The first winding end 211 is fitted into the first cutout 321. The size of the first cutout 321 is such that the first winding end 211 does not protrude from the envelope shape of the first outer core portion 32f or excessively limit the magnetic path area of the first outer core portion 32f. If the first winding end 211 does not protrude from the envelope shape of the first outer core portion 32f, the height and thickness of the reactor 1 can be reduced compared to a conventional reactor in which a winding end is placed on an upper face of an outer core portion. From the standpoint of maintaining the magnetic path area of the first outer core portion 32f and accommodating the first winding end 211 within the envelope shape of the first outer core portion 32f, the shape and dimensions of the first cutout 321 may also correspond to the shape and dimensions of the first winding end 211.

The second cutout 322 is recessed from the upper face toward the bottom face of the first outer core portion 32f. The second cutout 322 has a U-shape when the first outer core portion 32f is viewed in the X2 direction. Note that the shape of the second cutout 322 is not limited to the U-shape, and may also be a rectangular shape or a V-shape. The third winding end 213 of the second winding portion 22 is fitted into the second cutout 322. The second cutout 322 has a size with which the third winding end 213 does not protrude beyond the envelope shape of the first outer core portion 32f or excessively limit the magnetic path area of the first outer core portion 32f. If the third winding end 213 does not protrude from the envelope shape of the first outer core portion 32f, the height of the reactor 1 can be reduced, making it thinner compared to a conventional reactor in which a winding end is placed on an upper face of an outer core portion. From the standpoint of maintaining the magnetic path area of the first outer core portion 32f and accommodating the third winding end 213 within the envelope shape of the first outer core portion 32f, the shape and dimensions of the second cutout 322 may also correspond to the shape and dimensions of the third winding end 213. In the case of a flat reactor 1, the winding wires may be disposed in cutouts 321, 322, 323, and 324 such that the long sides of the coated flat wires extend along the long sides of the envelope shapes of the first outer core portion 32f and the second outer core portion 32s. In other words, the winding wires may be disposed in the cutouts 321, 322, 323, and 324 such that the short sides of the coated flat wires extend along the short sides of the envelope shapes of the first outer core portion 32f and the second outer core portion 32s. This arrangement of the winding wires can reduce the dimensions of the cutouts 321, 322, 323, and 324 along their heights and suppress a decrease in the magnetic path area in the outer core portions 32.

The first cutout 321 is provided at the end in the Y2 direction of the first outer core portion 32f, and the second cutout 322 is provided at the center portion of the first outer core portion 32f. This can secure a sufficient distance between the first winding end 211 of the first winding portion 21 and the third winding end 213 of the second winding portion 22. This facilitates connecting terminals to the first winding end 211 and the third winding end 213. Note that, as shown in FIG. 3, the second outer core portion 32s has a third cutout 323 at its end in the Y1 direction and a fourth cutout 324 at its center portion. The fourth winding end 214 extending from the second winding portion 22 is led out through the third cutout 323, and the second winding end 212 extending from the first winding portion 21 is led out through the fourth cutout 324.

### Constituent Material of Magnetic Core

The magnetic core 3 is constituted by a molded body of a composite material. In the molded body of the composite material, soft magnetic powder is dispersed in a resin. The molded body of the composite material is obtained by filling a mold with a fluid material in which soft magnetic powder is dispersed in unsolidified resin, and then solidifying the resin. The magnetic core 3 in this example is molded by disposing the coil 2 and the later-described spacers 4 inside the mold and filling the mold with the aforementioned fluid material. This method of molding the magnetic core 3 also applies to Embodiments 2 to 4, which will be described later. The resulting magnetic core 3 is a molded body in which the inner core portions 31 and the outer core portions 32 are integrated. Even a magnetic core 3 having a complex shape can be easily molded by forming the magnetic core 3 with a molded body of a composite material.

In the molded body of the composite material, the content of the soft magnetic powder in the resin of can be easily adjusted. Thus, the magnetic properties of the molded body of the composite material can be easily adjusted. In addition, the molded body of the composite material can be more easily formed even with a complicated shape, than a powder compact. The content of the soft magnetic powder in the molded body of the composite material is, for example, 20 vol % or more and 80 vol % or less. The content of the resin in the molded body of the composite material is, for example, 20 vol % or more and 80 vol % or less. These contents are proportions when the volume of the molded body of the composite material is 100%.

The soft magnetic powder is constituted by, for example, soft magnetic metal particles, coated particles, or soft magnetic non metal particles. The coated particles contain soft magnetic metal particles and an insulating coating provided on the outer periphery of each soft magnetic metal particle. The soft magnetic metal is, for example, pure iron or an iron-based alloy. The iron-based alloy is, for example, an Fe-Si alloy or an Fe-Ni alloy. The insulating coating is made of phosphate, for example. The soft magnetic non-metal is ferrite, for example.

The resin constituting the molded body of the composite material is, for example, a thermosetting resin or a thermoplastic resin. The thermosetting resin may be, for example, epoxy resin, phenolic resin, silicone resin, or urethane resin. Examples of thermoplastic resins include polyphenylene sulfide (PPS) resin, polybutylene terephthalate (PBT), polyamide (PA) resin, liquid crystal polymer (LCP), polyimide (PI) resin, and fluororesin. The polyamide resin is, for example, nylon 6, nylon 66, or nylon 9T.

The molded body of the composite material may contain a filler. The filler is made of, for example, alumina or silica. The filler improves heat dissipation and electrical insulation performance.

If necessary, the magnetic core 3 may be a combination of a molded body of a composite material and a powder compact. The powder compact is a compact obtained by compression molding soft magnetic powder. The proportion of the soft magnetic powder in the powder compact can be made higher than that in the molded body of the composite material. Thus, the magnetic properties of the magnetic core 3 including the powder compact are easily improved. Examples of magnetic properties include a relative permeability and a saturation magnetic flux density. As a specific combination of the powder compact and the molded body of the composite material, for example, the composite material is molded into a molded body so as to cover the outer periphery of an O-shaped powder compact.

### Spacer

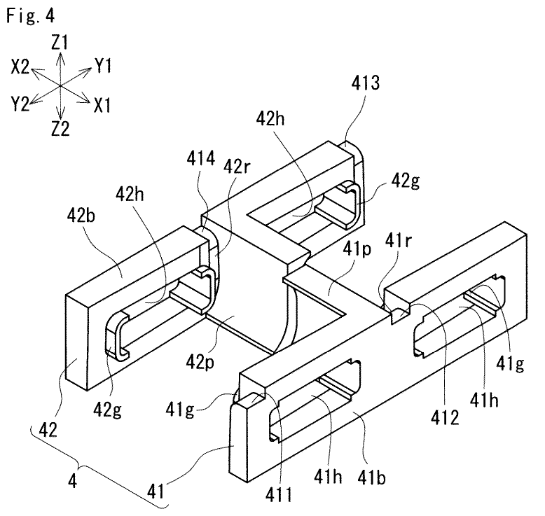

The spacers 4 are members for positioning the winding portions 21 and 22 relative to each other and integrating the coil 2 with the magnetic core 3 by being integrally molded with the magnetic core 3. As shown in FIG. 4, the spacers 4 in this example include two members, namely a first spacer 41 and a second spacer 42. The first spacer 41 and the second spacer 42 have the same shape, dimensions, and constituent material. The first spacer 41 will be mainly described below, and the description of the second spacer 42 is omitted. Note that, similar to the first spacer 41, the second spacer 42 has a base 42b, a protrusion 42p, a guide portion 42g, and a through-hole 42h. As shown in FIG. 4, the base 42b of the second spacer 42 has a third cutout 413 at its end in the Y1 direction and a fourth cutout 414 at its center portion. The fourth winding end 214 extending from the second winding portion 22 is led out through the third cutout 413, and the second winding end 212 extending from the first winding portion 21 is led out through the fourth cutout 414.

The first spacer 41 has a base 41b, a protrusion 41p, and guide portions 41g. The base 41b is a main part of the first spacer 41 and has a B-shape when viewed from the X1 or X2 direction. The base 41b has a rectangular shape when viewed from the Z1 or Z2 direction. The base 41b also has a rectangular shape when viewed from the Y1 or Y2 direction. The base 41b has a larger width than its length and height.

The envelope shape of the first spacer 41, that is, the envelope shape of the base 41b, is a rectangle having long sides and short sides. The “envelope shape” refers to a minimum quadrangular shape surrounding the base 41b when viewed from a direction along the axis of the first winding portion 21. The bottom face and the upper face that constitute the base 41b are faces corresponding to the long sides, and the two side faces that constitute the base 41b are faces corresponding to the short sides. Also, the bottom faces of the bases 41b and 42b each correspond to a first main face, and the upper faces of the bases 41b and 42b each correspond to a second main face. All of the upper face, bottom face, and both side faces include a flat surface.

The ratio D of the long side to the short side of the base 41b is, for example, 3.5 or more. This ratio D is a ratio with the dimension of the short side as a denominator and the dimension of the long side as a numerator. The larger the value of the ratio D, it can be said that the base 41b is flatter and thinner. The ratio D may also be 5.0 or more, 6.0 or more, or 7.0 or more. The upper limit of the ratio D may be set as appropriate in accordance with the required upper limit width of the reactor 1. An example upper limit of the ratio D is 11.0. The ratio D in this example is about 3.9.

The width of the base 41b is the same as the width of the coil 2, i.e., the total width of the first winding portion 21 and the second winding portion 22 arranged in parallel. The width of the base 41b may be larger or smaller than the width of the coil 2. If the width of the base 41b is larger than the width of the coil 2, the insulation coating of the coil 2 is less likely to be damaged.

The base 41b has a first cutout 411 and a second cutout 412. The first cutout 411 is provided at an end in the Y2 direction of the base 41b. The second cutout 412 is provided between the ends in the Y1 and Y2 directions of the base 41b.

The first cutout 411 is provided at a corner constituted by the upper face and a side face of the base 41b. The shape of the first cutout 411 when the base 41b is viewed in the X2 direction is a rectangular shape. Note that the shape of the first cutout 411 is not limited to a rectangular shape, and may also be any other polygonal shape or a fan shape. The first winding end 211 is fitted into the first cutout 411. The size of the first cutout 411 corresponds to the cross-sectional dimension of the winding wire. If the first winding end 211 does not protrude from the envelope shape of the base 41b, the height of the reactor 1 can be reduced, making it thinner compared to a conventional reactor in which a winding end is placed on an upper face of a spacer 4. From the standpoint of properly supporting the winding wire, the shape and dimensions of the first cutout 411 may also correspond to the shape and dimensions of the first winding end 211.

The second cutout 412 is recessed from the upper face toward the bottom face of the base 41b. The shape of the second cutout 412 when the base 41b is viewed in the X2 direction is a rectangular shape. Note that the shape of the second cutout 412 is not limited to a rectangular shape, and may also be any other polygonal shape or a U-shape. The third winding end 213 of the second winding portion 22 is fitted into the second cutout 412. The size of the second cutout 412 corresponds to the cross-sectional dimension of the winding wire. If the third winding end 213 does not protrude from the envelope shape of the base 41b, the height of the reactor 1 can be reduced, making it thinner compared to a conventional reactor in which a winding end is placed on an upper face of a spacer 4. From the standpoint of properly supporting the winding wire, the shape and dimensions of the second cutout 412 may also correspond to the shape and dimensions of the third winding end 213.

A face of the base 41b that is oriented in the X2 direction includes guide grooves 41r. Although the shape of each guide groove 41r is invisible in FIG. 4, the guide groove 41r has a J-shape similar to that of the guide groove 42r of the base 42b. The guide grooves 41r are provided at two locations, namely an end in the Y2 direction of the base 41b and a center in its face oriented in the X2 direction. The guide groove 41r provided at the end in the Y2 direction guides the winding wire of a turn of the first winding portion 21 that faces the base 41b, from the bottom face toward the upper face of the first winding portion 21. The guide groove 41r provided at the center portion guides the winding wire of a turn of the second winding portion 22 that faces the base 41b, from the bottom face toward the upper face of the second winding portion 22. The winding wire pulled up to the upper face of the first winding portion 21 along the guide groove 41r is bent flatwise, then extends in the X1 direction, and is thus led to the first winding end 211. The winding wire pulled up to the upper face of the second winding portion 22 along the guide groove 41r is bent flatwise, then extends in the X1 direction, and is thus led to the third winding end 213.

The base 41b has two through-holes 41h. The two through-holes 41h extend through the base 41b so as to connect the face of the base 41b that is oriented in the X1 direction and the surface thereof that is oriented in the X2 direction. The first inner core portion 31f and the second inner core portion 31s extend through the respective through-holes 41h. The shape of each through-hole 41h when viewed in the X1 or X2 direction is a rectangular shape except for the portions at which the guide portions 41g, which will be described later, are provided.

Further, the base 41b has a plurality of guide portions 41g. The guide portions 41g are portions for positioning the coil 2 relative to the spacer 4 by fitting the winding portions 21 and 22 onto the outer periphery of the guide portions 41g. Each guide portion 41g protrudes in the X2 direction from a face of the base 41b that is oriented in the X1 direction, and extends to a part of the inner periphery of the through-hole 41h. The number of guide portions 41g is two for each through-hole 41h, i.e., four in total. The shape of each guide portion 41g in this example is a C-shape. The C-shaped guide portions 41g are provided at both ends of each through-hole 41h such that their openings face each other.

The protrusion 41p extends in the X2 direction from a center portion of the base 41b. The protrusion 41p is disposed between the winding portions 21 and 22 to separate the winding portions 21 and 22 from each other and position the winding portions 21 and 22. The protrusion 41p in this example has an I-shape in which the widths of the bottom face and the upper face are greater than that of an intermediate portion between the bottom face and the upper face. Both side faces of the protrusion 41p include arc-shaped curved surfaces corresponding to the respective side faces of the winding portions 21 and 22. Note that an upper portion, i.e., a region in the Z1 direction, of the side face of the protrusion 41p that faces the second winding portion 22 includes a flat surface. That is, the width of the upper face of the protrusion 41p is smaller than that of the bottom face. This configuration allows the third winding end 213 of the second winding portion 22 to be led out in parallel along aforementioned flat surface of the protrusion 41p.

The protrusion 41p of the first spacer 41 and the protrusion 42p of the second spacer 42 are spaced apart from each other. The bottom face of the protrusion 41p and the bottom face of the protrusion 42p are arranged in parallel along the X1 or X2 direction without displacement in the Y1 or Y2 direction. Meanwhile, the upper face of the protrusion 41p and the upper face of the protrusion 42p are displaced from each other in the Y1 and Y2 directions, and arranged in parallel along the X1 or X2 direction.

The spacers 4 are made of an insulating material. Examples of the material include PPS resin, LCP, PA resin, PBT resin, and acrylonitrile-butadiene-styrene (ABS) resin or polytetrafluoroethylene (PTFE) resin. In addition, the material of the spacers 4 may be, for example, a thermosetting resin such as unsaturated polyester resin, epoxy resin, urethane resin, or silicone resin. These resins may contain a ceramic filler. The ceramic filler is, for example, nonmagnetic powder of alumina, silica, or the like. Front and rear faces of coil, outer core portion, and spacer

The upper faces of the above-described coil 2, outer core portions 32, and spacers 4 are flush with each other, and their bottom faces are also flush with each other. Thus, by using at least one of the upper face and the lower face of the reactor 1 as an installation surface, all of the constituent members, namely the coil 2, the outer core portions 32, and the spacers 4, can be brought into surface contact with an installation object, thereby enabling efficient heat dissipation. In particular, by using both the upper and lower faces of the reactor 1 as installation surfaces, heat can be dissipated from the front and rear faces of the reactor 1, thereby achieving excellent heat dissipation. Efficient heat dissipation is enabled by the configuration in which the coil 2, the outer core portions 32, and the spacers 4 have upper faces that are flush with each other and lower faces that are also flush with each other, and by using at least one of the upper face and the lower face of the reactor 1 as an installation surface. This is also common in Embodiments 2 to 4, which will be described later.

### Embodiment 2

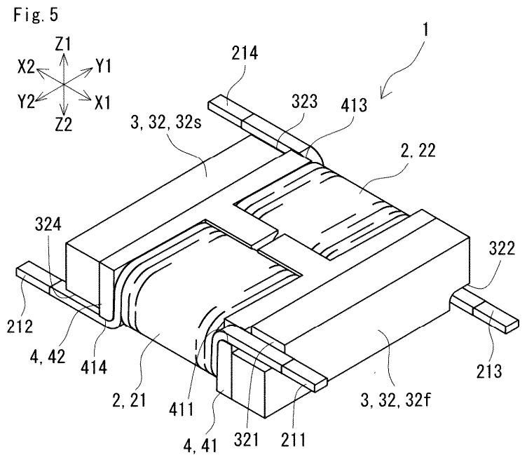

Next, a reactor 1 according to Embodiment 2 different from Embodiment 1 will be described with reference to FIG. 5. The reactor 1 according to Embodiment 2 has a configuration in which the first to fourth winding ends 211 to 214 are led out from two ends of the outer core portions 32. The following description focuses on differences from Embodiment 1, while points in common with Embodiment 1 are omitted. Note that, in FIG. 5, the first spacer 41 has a second cutout 412 (not shown) at its end in the Y1 direction.

First, the reactor 1 according to Embodiment 2 has different lead-out positions for the winding ends of the coil 2. Specifically, the lead-out positions for the first winding end 211 in Embodiment 2 are the same as those for the first winding end 211 in Embodiment 1. The second winding end 212 is led out from a corner in the Y2 and Z2 directions when the first winding portion 21 is viewed in the X1 direction, and extends in the X2 direction. The lead-out position for the fourth winding end 214 in Embodiment 2 is the same as that for the fourth winding end 214 in Embodiment 1. The third winding end 213 is led out from a corner in the Y1 and Z2 directions when the second winding portion 22 is viewed in the X2 direction, and extends in the X1 direction.

In this example, the second cutout 322 and the second cutout 412 in Embodiment 1 are provided at an end in the Y1 direction of the first outer core portion 32f, and the fourth cutout 324 and the fourth cutout 414 in Embodiment 1 are provided at an end in the Y2 direction of the second outer core portion 32s, in accordance with the above-described shape of the coil 2.

In the reactor 1 according to Embodiment 2, when the magnetic core 3 is viewed in the Z2 direction, the first to fourth winding ends 211 to 214 are led out from positions corresponding to the respective corners. That is, the winding ends 211, 212, 213, and 214 are spaced apart from each other, thus facilitating connection of terminals to the respective winding ends 211, 212, 213, and 214.

### Embodiment 3

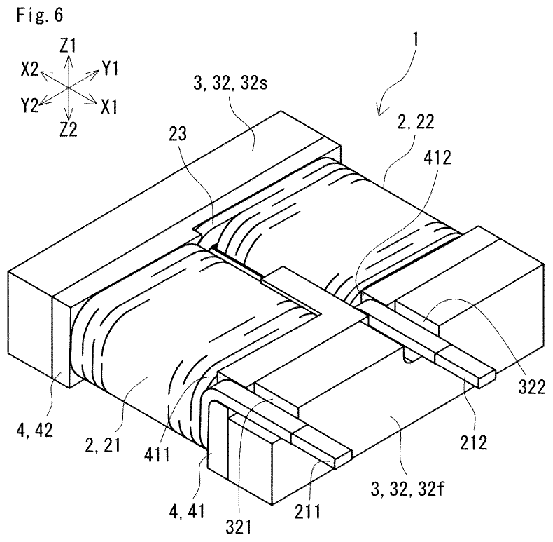

Next, a reactor 1 according to Embodiment 3 different from the reactor 1 according to Embodiment 1 will be described with reference to FIGS. 6 to 9. As shown in FIG. 6, the reactor 1 according to Embodiment 3 has the coil 2 with a shape different from that of Embodiment 1, and accordingly the shapes of the spacers 4 are also different from those of Embodiment 1. The following description focuses on differences from Embodiment 1, while points in common with Embodiment 1 are omitted.

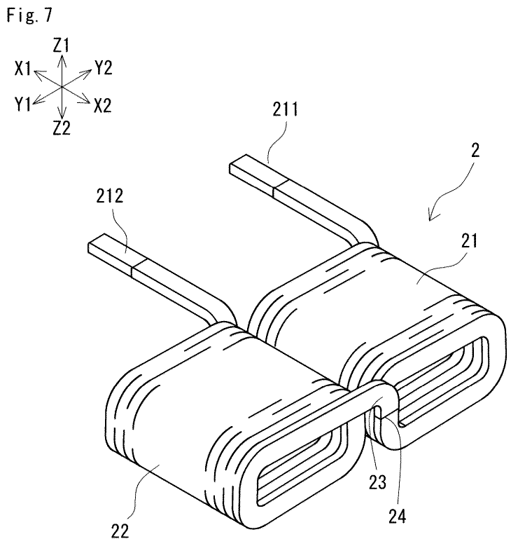

As shown in FIG. 7, the coil 2 of the reactor 1 according to Embodiment 3 includes the first winding portions 21 and the second winding portion 22 that are connected by a coupling portion 23. The coupling portion 23 is a Z-shaped portion that connects turns constituting end faces in the X2 direction of the first and second winding portions 21 and 22. The coupling portion 23 is formed by a portion of the winding wires constituting the winding portions 21 and 22. A joint portion 24 is provided at an intermediate portion of the coupling portion 23. The joint portion 24 is a portion at which the winding wires constituting the first and second winding portions 21 and 22 are joined to each other. The joint portion 24 in this example is formed by bringing ends of the winding wires constituting the first and second winding portions 21 and 22 into contact with each other and joining them by cold pressure welding. The coil 2 can be obtained, for example, by forming a most part of the winding portions 21 and 22, joining the winding ends by cold pressure welding, and then forming the remainder of the winding portions 21 and 22.

The first winding end 211 is led out in the X1 direction from the first winding portion 21. The second winding end 212 is led out in the X1 direction from the second winding portion 22. When the first winding portion 21 is viewed in the X2 direction, the first winding end 211 is led out from a corner in the Y2 and Z1 directions of the first winding portion 21. When the second winding portion 22 is viewed in the X2 direction, the second winding end 212 is led out from a corner in the Y2 and Z1 directions of the second winding portion 22.

Unlike this example, the coil 2 may be formed as a single winding wire extending from the first winding end 211, through the first winding portion 21, the coupling portion 23, the second winding portion 22, to the second winding end 212. In this case, the coupling portion 23 has no joint portion 24.

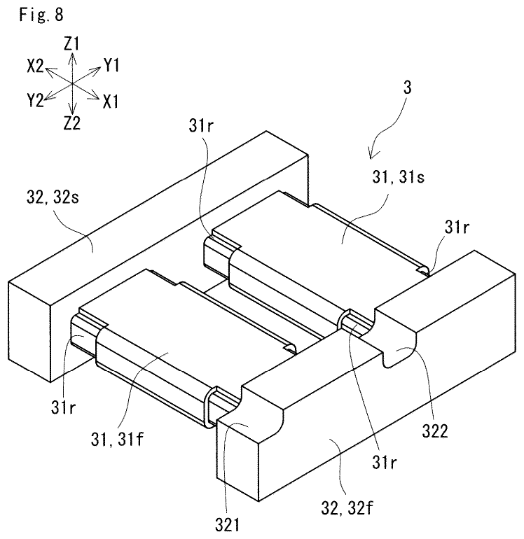

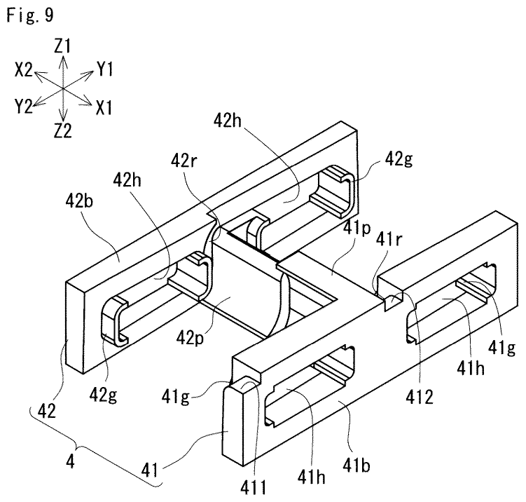

As shown in FIGS. 8 and 9, the configurations of the magnetic core 3 and the first spacer 41 are substantially the same as those of the magnetic core 3 and the first spacer 41 according to Embodiment 1. Meanwhile, as shown in FIG. 9, the second spacer 42 has a different configuration from that of the second spacer 42 according to Embodiment 1. Specifically, the base 42b of the second spacer 42 has no cutouts corresponding to the first and second cutouts 411 and 412 in the base 41b of the first spacer 41. Also, the shape of the protrusion 42p of the second spacer 42 differs from that of the protrusion 41p of the first spacer 41. The protrusion 42p has a triangular prism shape having an apex in the Z1 direction. The width of the bottom face of the protrusion 42p is the same as that of the bottom face of the protrusion 41p. The height of the protrusion 42p is lower than that of the protrusion 41p. With the protrusion 42p having such a shape, the coupling portion 23 can be disposed without interfering with the protrusion 42p in a face of the base 42b that is oriented in the X1 direction.

Further, as shown in FIG. 6, the first winding end 211 is led out through the first cutout 321 and the first cutout 411, and the second winding end 212 is led out through the second cutout 322 and the second cutout 412.

### Embodiment 4

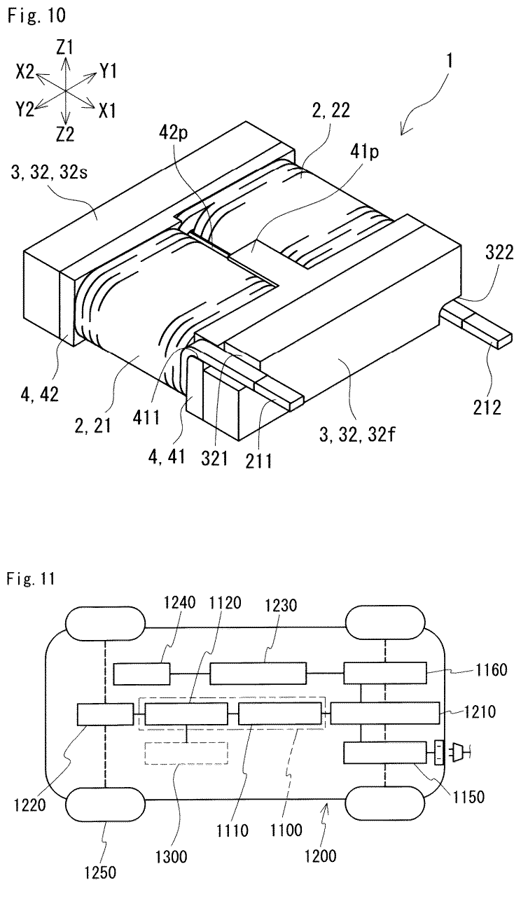

Next, a reactor 1 according to Embodiment 4 different from Embodiment 3 will be described with reference to FIG. 10. The reactor 1 according to Embodiment 4 has a configuration in which the first and second winding ends 211 and 212 are led out from respective ends of the first outer core portion 32f. The following description focuses on differences from Embodiment 3, while points in common with Embodiment 3 are omitted. Note that, in FIG. 10, the first spacer 41 has a second cutout 412 (not shown) at its end in the Y1 direction.

First, the reactor 1 according to Embodiment 4 differs in the lead-out positions for the winding ends of the coil 2. Specifically, the lead-out position for the first winding end 211 in Embodiment 4 are the same as that for the first winding end 211 in Embodiment 3. The second winding end 212 is led out from a corner in the Y1 and Z2 directions when the second winding portion 22 is viewed in the X2 direction, and extends in the X1 direction.

The second cutout 322 and the second cutout 412 according to Embodiment 4 are provided at an end in the Y1 direction of the first outer core portion 32f, in accordance with the above-described shape of the coil 2.

In the reactor 1 according to Embodiment 4, when the magnetic core 3 is viewed in the Z2 direction, the first and second winding ends 211 and 212 are led out from positions corresponding to two ends of the first outer core portion 32f. That is, the winding ends 211 and 212 are spaced apart from each other, facilitating connection of terminals to the respective winding ends 211 and 212.

### Embodiment 5

### Converter and Power Conversion Apparatus

Each of the reactors 1 according to Embodiments 1 to 4 can be used in applications that satisfy the following electrical conditions. Examples of the electrical conditions include a maximum direct current from about 100 A to about 1000 A, an average voltage from about 100 V to about 1000 V, and an operating frequency from about 5 kHz to about 100 kHz. The reactor 1 according to any of Embodiments 1 to 4 can typically be used as a constituent component of a converter mounted in a vehicle 1200, such as an electric vehicle, a hybrid vehicle, or a fuel-cell vehicle, or as a constituent component of a power conversion apparatus that includes this converter.

As shown in FIG. 11, a vehicle 1200 includes a main battery 1210, a power conversion apparatus 1100 connected to the main battery 1210, and a motor 1220 driven by the power fed from the main battery 1210 and is used for traveling. The motor 1220 is typically a three-phase alternating current motor. The motor 1220 drives the wheels 1250 during travel, and functions as a generator during regeneration. In the case of a hybrid vehicle, the vehicle 1200 includes an engine 1300 in addition to the motor 1220. FIG. 11 shows an example in which a charging portion of the vehicle 1200 is an inlet. Although not shown, the charging portion of the vehicle 1200 may include a plug.

The power conversion apparatus 1100 includes a converter 1110 that is connected to the main battery 1210, and an inverter 1120 that is connected to the converter 1110. The inverter 1120 converts between direct current and alternating current. While the vehicle 1200 travels, the converter 1110 in this example steps up an input voltage of the main battery 1210 from about 200 V to 300 V to a voltage of about 400 V to 700 V, and feeds the power to the inverter 1120. During regeneration, the converter 1110 steps down an input voltage that is output from the motor 1220, to a direct current voltage suitable for the main battery 1210, and charges the main battery 1210. The input voltage is a direct current voltage. While the vehicle 1200 travels, the inverter 1120 converts the direct current whose voltage has been stepped up by the converter 1110, to a predetermined alternating current, and feeds the power to the motor 1220. During regeneration, the inverter 1120 converts an alternating current from the motor 1220 into a direct current and outputs it to the converter 1110.

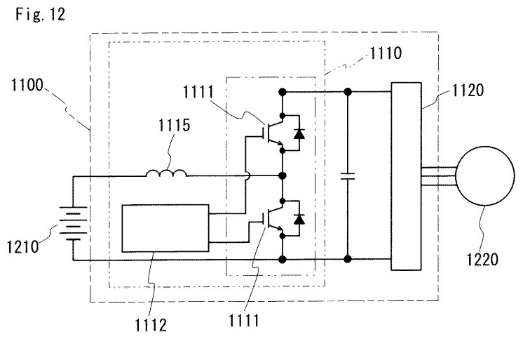

As shown in FIG. 12, the converter 1110 includes a plurality of switching elements 1111, a drive circuit 1112 that controls the operation of the switching elements 1111, and a reactor 1115. The converter 1110 performs conversion on an input voltage by repeated ON/OFF switching. Here, conversion of an input voltage means stepping up or down the input voltage. Power devices such as field-effect transistors or insulated gate bipolar transistors are used as the switching elements 1111. Using the properties of the coil, which attempts to resist changes in current that is about to flow through the circuit, the reactor 1115 serves to smooth any changes in the current that is about to increase or decrease due to a switching operation. The reactor 1 according to any of Embodiments 1 to 4 is provided as the reactor 1115. By including the reactor 1, the power conversion apparatus 1100 and the converter 1110 exhibit excellent performance.

The vehicle 1200 includes, in addition to the converter 1110, a power feeding device converter 1150 connected to the main battery 1210, and an auxiliary equipment power supply converter 1160 that converts a high voltage of the main battery 1210 to a low voltage, as shown in FIG. 11. The auxiliary equipment power supply converter 1160 is connected to the main battery 1210 and a sub-battery 1230 that serves as a power source for auxiliary equipment 1240. The converter 1110 typically performs DC-DC conversion. The power feeding device converter 1150 and the auxiliary equipment power supply converter 1160 perform AC-DC conversion. Some type of power feeding device converter 1150 may also perform DC-DC conversion. Reactors for the power feeding device converter 1150 and the auxiliary equipment power supply converter 1160 can have the same configuration as the reactor 1 according to any of Embodiments 1 to 4, with modifications to size, shape, or the like as appropriate. Further, the reactor 1 according to any of Embodiments 1 to 4 can also be used in converters that convert input power and that only step up or step down the voltage.

The present disclosure is not limited by these examples but is defined by the claims, and is intended to encompass all modifications made within the meaning and scope equivalent to the claims.

Each of the cutouts provided in the outer core portions may be a hole. That is, the cutout as used herein may include a hole. For example, a hole extending through the outer core portion in the X1 or X2 direction may be provided, and each winding end may be passed through the interior of this hole. In this case, a tubular portion may be provided extending from the base of the spacer in a direction opposite to the protrusion. The outer core portion may be formed on the outer periphery of the tubular portion, and the winding ends may be passed through the interior of the tubular portion.

The winding ends according to each embodiment are led out with the long sides of the coated flat wire extending along the Y1 or Y2 direction. Alternatively, the winding ends may be led out with the long sides of the coated flat wire extending along the Z1 or Z2 direction. In this case, cutouts corresponding to the orientations of the winding ends to be led out may be provided in the outer core portion.

The shape of the magnetic core may be a θ-shape, instead of an O-shape. The θ-shaped magnetic core includes one middle core portion, two side core portions, and two end core portions. The middle core portion is disposed inside the coil. The side core portions are arranged parallel to the middle core portion on the respective outer sides the coil. That is, the middle core portion is sandwiched between the two side core portions. One of the two end core portions connects first ends of the middle core portion and the side core portions arranged in parallel. The remaining one end core portion connects second ends of the middle core portion and the side core portions arranged in parallel. In other words, the θ-shaped magnetic core has a shape obtained by integrally combining two E-shaped core pieces. All of the middle core portion, the side core portions, and the end core portions are integrally molded into a molded body of a composite material. The winding ends led out from the coil are led out through cutouts provided in one of the end core portions or both end core portions. When the magnetic core has a θ-shape, the middle core portion corresponds to the inner core portion, and the end core portions correspond to the outer core portions.

1. A reactor comprising:
a coil constituted by a winding wire; and
a magnetic core having: an inner core portion disposed inside the coil; and an outer core portion disposed outside the coil,
wherein the outer core portion has a cutout, and an end of the winding wire is led out through the cutout.

2. The reactor according to claim 1, further comprising-including;
a spacer disposed between an end face of the coil and the outer core portion,
wherein the spacer has a cutout through which the end of the winding wire is led out.

3. The reactor according to claim 1,
wherein the coil has:
a first winding portion and a second winding portion that are independent members arranged in parallel;
a first winding end and a second winding end that are led out from the first winding portion; and
a third winding end and a fourth winding end that are led out from the second winding portion,
the outer core portion includes:
a first outer core portion facing a first end face of the coil; and
a second outer core portion facing a second end face of the coil, the cutout includes:
a first cutout provided at one of a first end and a second end of the first outer core portion;
a second cutout provided between the first end and the second end of the first outer core portion;
a third cutout provided at one of a first end and a second end of the second outer core portion; and
a fourth cutout provided between the first end and the second end of the second outer core portion,
the first winding end is led out through the first cutout,
the second winding end is led out through the fourth cutout,
the third winding end is led out through the second cutout, and
the fourth winding end is led out through the third cutout.

4. The reactor according to claim 1,
wherein the coil has:
a first winding portion and a second winding portion that are independent members arranged in parallel;
a first winding end and a second winding end that are led out from the first winding portion; and
a third winding end and a fourth winding end that are led out from the second winding portion,
the outer core portion includes:
a first outer core portion facing a first end face of the coil; and
a second outer core portion facing a second end face of the coil, the cutout includes:
a first cutout provided at a first end of the first outer core portion;
a second cutout provided at a second end of the first outer core portion;
a third cutout provided at a first end of the second outer core portion; and
a fourth cutout provided at a second end of the second outer core portion,
the first winding end is led out through the first cutout,
the second winding end is led out through the fourth cutout,
the third winding end is led out through the second cutout, and
the fourth winding end is led out through the third cutout.

5. The reactor according to claim 1,
wherein the coil has:
a first winding portion and a second winding portion arranged in parallel;
a coupling portion connecting the first winding portion and the second winding portion;
a first winding end led out from the first winding portion; and
a second winding end led out from the second winding portion,
the coupling portion is constituted by a portion of the winding wire,
the cutout includes:
a first cutout provided at one of a first end and a second end of the outer core portion; and
a second cutout provided between the first end and the second end of the outer core portion,
the first winding end is led out through the first cutout, and
the second winding end is led out through the second cutout.

6. The reactor according to claim 1,
wherein the coil has:
a first winding portion and a second winding portion arranged in parallel;
a coupling portion connecting the first winding portion and the second winding portion;
a first winding end led out from the first winding portion; and
a second winding end led out from the second winding portion,
the coupling portion is constituted by a portion of the winding wire,
the cutout includes:
a first cutout provided at a first end of the outer core portion; and
a second cutout provided at a second end of the outer core portion,
the first winding end is led out through the first cutout, and
the second winding end is led out through the second cutout.

7. The reactor according to claim 1,
wherein the outer core portion has a rectangular envelope shape having a long side and a short side as viewed from a direction along an axis of the coil, and
a ratio of the long side to the short side is 5.0 or more.

8. The reactor according to claim 1,
wherein the coil has a rectangular envelope shape having a long side and a short side as viewed from a direction along an axis of the coil, and
a ratio of the long side to the short side is 2.5 or more.

9. The reactor according to claim 2,
wherein the spacer has a rectangular envelope shape having a long side and a short side as viewed from a direction along an axis of the coil, and
a ratio of the long side to the short side is 5.0 or more.

10. The reactor according to claim 2,
wherein the coil has a first coil face and a second coil face opposing each other,
the outer core portion has a first outer core face and a second outer core face opposing each other,
the spacer has a first main face and a second main face opposing each other,
the first coil face, the first outer core face, and the first main face are flush with each other, and
the second coil face, the second outer core face, and the second main face are flush with each other.

11. A converter comprising the reactor according to claim 1.

12. A power conversion apparatus comprising the converter according to claim 11.

13. The reactor according to claim 3, further including;
a spacer disposed between an end face of the coil and the outer core portion,
wherein the spacer has a cutout through which the end of the winding wire is led out.

14. The reactor according to claim 4, further including;
a spacer disposed between an end face of the coil and the outer core portion,
wherein the spacer has a cutout through which the end of the winding wire is led out.

15. The reactor according to claim 5, further including;
a spacer disposed between an end face of the coil and the outer core portion,
wherein the spacer has a cutout through which the end of the winding wire is led out.

16. The reactor according to claim 6, further including;
a spacer disposed between an end face of the coil and the outer core portion,
wherein the spacer has a cutout through which the end of the winding wire is led out.

17. A converter comprising the reactor according to claim 2.

18. A power conversion apparatus comprising the converter according to claim 11.
